(19) United States
(12) Patent Application Publication
(10) Pub. No.: US 2022/0262167 A1
(43) Pub. Date: Aug. 18, 2022

(54) INSPECTION ASSISTANCE PROGRAM, INSPECTION ASSISTANCE SYSTEM, AND INSPECTION ASSISTANCE APPARATUS CONTROL METHOD

(71) Applicant: ISUZU MOTORS LIMITED, Tokyo (JP)

(72) Inventors: Akira IMAI, Fujisawa-shi, Kanagawa (JP); Masakazu ISHIMARU, Fujisawa-shi, Kanagawa (JP)

(21) Appl. No.: 17/618,752

(22) PCT Filed: Jun. 11, 2020
(86) PCT No.: PCT/JP2020/022987

§ 371 Date: Dec. 13, 2021

(30) Foreign Application Priority Data
Jun. 13, 2019 (JP) 2019-110530

(51) Int. Cl. G07C 5/00; G07C 5/08; B60W 50/14

(52) U.S. Cl. CPC G07C 5/006; B60W 2050/146; B60W 50/14; G07C 5/0816

(57) ABSTRACT

An inspection support program is a program for supporting inspection of a vehicle, and causes a computer to function as a vehicle identification number obtainment unit 252 that obtains a vehicle identification number indicating a type of the vehicle, and a display control unit 254 that causes a display unit 23 to display a plurality of inspection screens corresponding to a plurality of inspection items in an order associated with the type of the vehicle indicated by the vehicle identification number. For example, the display control unit 254 displays lastly an inspection screen corresponding to an inspection item to be performed at a driver's seat of the vehicle.

### TECHNICAL FIELD

The present disclosure relates to an inspection support program, an inspection support system, and a control method for an inspection support device that support inspection of a vehicle.

### BACKGROUND ART

A related art discloses a technique of displaying inspection items in an order according to features (a steering wheel position, a vehicle body shape, and the number of doors) of a vehicle from among a plurality of inspection orders (for example, see Patent Literature 1).

### CITATION LIST

### Patent Literature

Patent Literature 1: JP-A-2015-127918

### SUMMARY OF INVENTION

### Technical Problem

However, even in a vehicle having the same features, when a type of the vehicle differs, an installation position of a device installed in the vehicle may differ. In this case, a position displayed as an installation position of a device corresponding to an inspection item is different from a position where the device corresponding to the inspection item is actually installed. Therefore, when the inspection items are displayed in the order according to the features of the vehicle, an amount of movement at the time of inspection increases, and work time of inspection work may increase.

The present disclosure has been made in view of these points, and an object of the present disclosure provides a technique for performing inspection in an order suitable for a vehicle.

### Solution to Problem

A first illustrative aspect of the present disclosure provides an inspection support program for supporting inspection of a vehicle, the inspection support program causing a computer to function as: a vehicle identification number obtainment unit that obtains a vehicle identification number indicating a type of the vehicle; and a display control unit configured to control a display unit to display a plurality of inspection screens corresponding to a plurality of inspection items in an order associated with the type of the vehicle indicated by the vehicle identification number.

For example, the display control unit may be configured to control the display unit to display the inspection screen corresponding to an inspection item to be performed at a driver's seat of the vehicle lastly.

The display control unit may be configured to, after all of the plurality of inspection screens are displayed, control the display unit to display a remote roll call screen for performing a roll call to be performed by an administrator who manages operation of the vehicle.

For example, the display control unit may be configured to change the order in a case the computer receives an instruction of not to perform inspection corresponding to the inspection screen displayed on the display unit.

For example, the display control unit may be configured to display the plurality of inspection screens corresponding to the plurality of inspection items in an order of going around the vehicle from front of the vehicle to a driver's seat of the vehicle.

The plurality of inspection items may include: a first inspection item corresponding to an inspection item to be performed at the front; a second inspection item corresponding to an inspection item to be performed at a periphery of the vehicle; and a third inspection item corresponding to an inspection item to be performed at the driver's seat, and the display control unit may be configured to: display firstly a first inspection screen corresponding to the first inspection item; and display lastly a third inspection screen corresponding to the third inspection item.

A second illustrative aspect of the present disclosure provides an inspection support system for supporting inspection of a vehicle, the inspection support system including: a vehicle identification number obtainment unit that obtains a vehicle identification number indicating a type of the vehicle; and a display control unit configured to control an information terminal of a user, who performs inspection of the vehicle, to display a plurality of inspection screens corresponding to a plurality of inspection items in an order associated with the type of the vehicle indicated by the vehicle identification number.

A third illustrative aspect of the present disclosure provides a control method for an inspection support device for supporting inspection of a vehicle, the control method including causing the inspection support device to perform: obtaining a vehicle identification number indicating a type of the vehicle; and controlling a display unit to display a plurality of inspection screens corresponding to a plurality of inspection items in an order associated with the type of the vehicle indicated by the vehicle identification number.

A still another illustrative aspect of the present disclosure provides a computer-readable medium storing an inspection support program for supporting inspection of a vehicle readable by a computer, the inspection support program, when executed by the computer, causing the inspection support device to perform: obtaining a vehicle identification number indicating a type of the vehicle; and controlling a display unit to display a plurality of inspection screens corresponding to a plurality of inspection items in an order associated with the type of the vehicle indicated by the vehicle identification number.

### ADVANTAGEOUS EFFECTS OF INVENTION

According to the present disclosure, it is possible to perform inspection in an order suitable for a vehicle.

### BRIEF DESCRIPTION OF DRAWINGS

FIG. 1 is a diagram illustrating a configuration of an inspection support system according to an embodiment.

FIG. 2 is a diagram illustrating a screen that is displayed by an inspection support device immediately after an inspection application is started.

FIG. 3 is a schematic diagram illustrating a display order of inspection screens corresponding to a type of a vehicle.

FIG. 4 is a diagram illustrating a configuration of a vehicle.

FIG. 5 is a diagram illustrating a configuration of the inspection support device.

FIG. 6 is a schematic diagram of a data table in which vehicle registration information, a wireless identification number, a vehicle identification number, and an inspection execution item are associated.

FIG. 7 is a schematic diagram of a data table in which the vehicle identification number and a type of a vehicle are associated.

FIG. 8 is a schematic diagram of a data table in which a type of a vehicle is associated with a plurality of inspection items.

FIG. 9 is a schematic diagram of a data table in which a display order and the inspection item are associated for each type of vehicle.

FIG. 10 is a schematic diagram illustrating an example of an inspection screen.

FIG. 11 is a schematic diagram illustrating an example of an inspection result screen.

FIG. 12 is a schematic diagram illustrating an example of a remote roll call screen.

### DESCRIPTION OF EMBODIMENTS

### Overview of Inspection Support System S

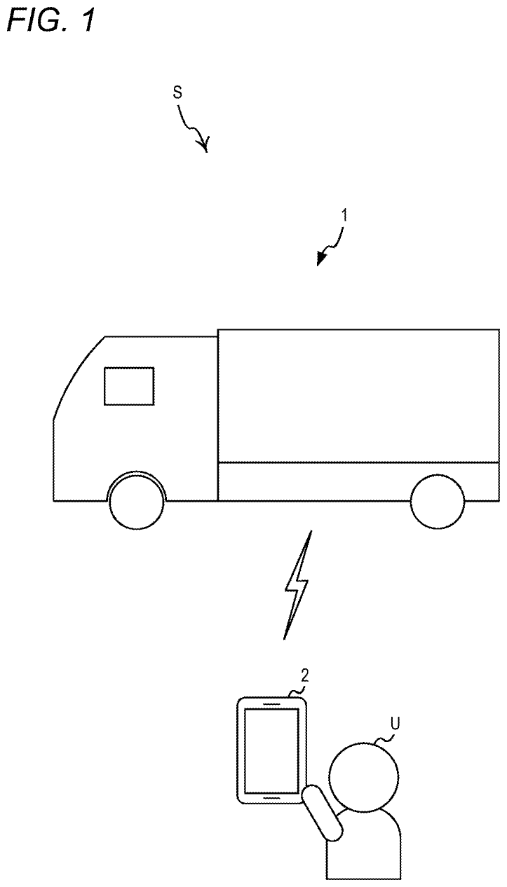

FIG. 1 is a diagram illustrating a configuration of an inspection support system S according to an embodiment. The inspection support system S includes an inspection support device 2 for supporting inspection of a vehicle 1. The vehicle 1 is a commercial vehicle, and is, for example, a truck. The inspection support device 2 is a device managed by a business operator who inspects the vehicle 1, and is, for example, an information terminal such as a smartphone or a tablet.

The inspection support device 2 displays, on a display, an inspection item and an inspection method required for inspection of the vehicle 1 when an inspection application software (hereinafter, referred to as an “inspection application”) is started. The inspection support device 2 receives an operation of a user U who inputs an inspection result.

The inspection support device 2 communicates with the vehicle 1 by wireless communication via an in-vehicle wireless device mounted on the vehicle 1. For example, the inspection support device 2 communicates with the vehicle 1 by Wi-Fi (registered trademark) or Bluetooth (registered trademark). The inspection support device 2 transmits, for example, instruction information for changing a state of equipment of the vehicle 1 to the vehicle 1 by wireless communication.

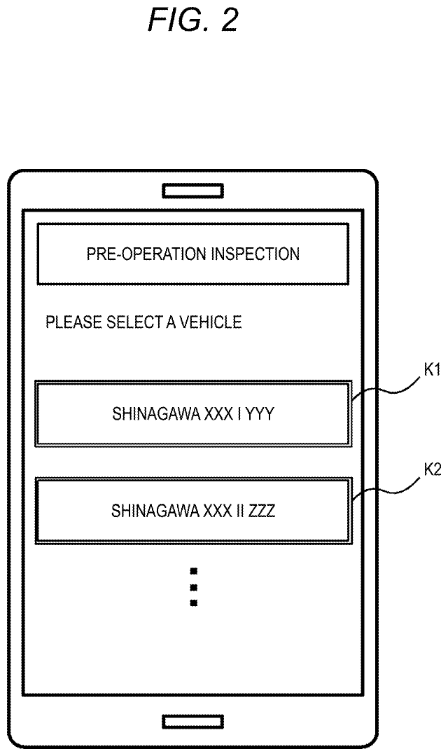

FIG. 2 is a diagram illustrating a screen that is displayed by the inspection support device 2 immediately after the inspection application is started. As illustrated in FIG. 2, the inspection support device 2 displays a screen for selecting the vehicle 1 to be inspected. In the example of FIG. 2, an operation key K1 for selecting a vehicle with vehicle registration information of “Shinagawa XXX I YYY” and an operation key K2 for selecting a vehicle with vehicle registration information of “Shinagawa XXX II ZZZ” are displayed. The vehicle registration information is information for specifying the vehicle 1, and is registered in advance by the user U. For example, the vehicle registration information is an automobile registration number of the vehicle 1.

When an operation of selecting the vehicle 1 is performed in the screen of FIG. 2, an inspection item necessary for inspection of the selected vehicle 1 is displayed. The user U performs inspection corresponding to the displayed inspection item, and inputs an inspection result to the inspection support device 2. When an inspection item to be inspected by changing a state of equipment of the vehicle 1 is displayed, the inspection support device 2 transmits instruction information for changing the state of the equipment corresponding to the inspection item to the vehicle 1. In this way, the user U can inspect the vehicle 1 without directly operating the vehicle 1.

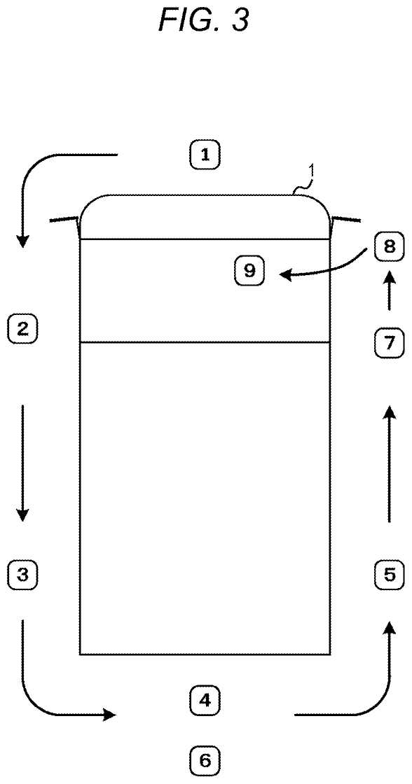

The inspection support device 2 displays an inspection screen corresponding to an inspection item of the vehicle 1 according to an order corresponding to the type of the selected vehicle 1. FIG. 3 is a schematic diagram illustrating a display order of inspection screens corresponding to the type of the vehicle 1. Numbers surrounded by squares with rounded corners in FIG. 3 indicate the display order of inspection screens corresponding to inspection items of the vehicle 1. In the example of FIG. 3, the inspection support device 2 firstly displays an inspection screen corresponding to an inspection item to be performed by the user U at the front of the vehicle 1 as a first inspection screen, and displays the inspection screens corresponding to the inspection items in an order in which the user U goes around the vehicle 1. The inspection support device 2 lastly displays an inspection screen corresponding to an inspection item to be performed at a driver's seat of the vehicle 1 as a ninth inspection screen. In this way, the user U can perform the inspection in an order suitable for the vehicle, in which a moving distance of the user in inspecting the vehicle 1 is relatively short.

### Configuration of Vehicle 1

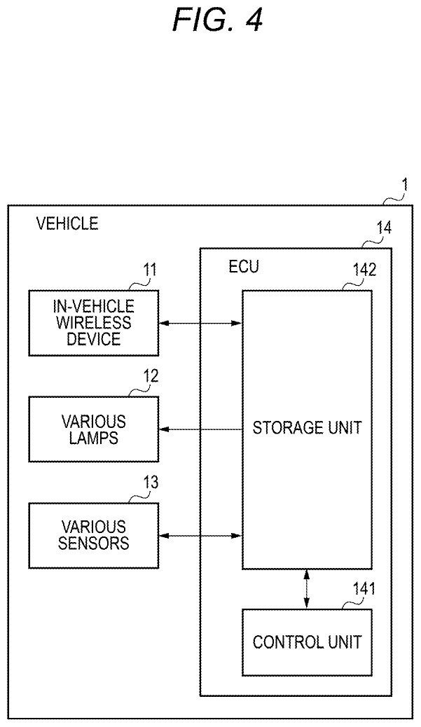

FIG. 4 is a diagram illustrating a configuration of the vehicle 1. The vehicle 1 includes an in-vehicle wireless device 11, various lamps 12, various sensors 13, and an electronic control unit (ECU) 14. The ECU 14 includes a storage unit 141 and a control unit 142.

The in-vehicle wireless device 11 is a device for communicating with the inspection support device 2 by wireless communication. The in-vehicle wireless device 11 transmits information notified from the control unit 142 to the inspection support device 2. The in-vehicle wireless device 11 notifies the control unit 142 of information received from the inspection support device 2. The in-vehicle wireless device 11 may transmit the information, which is notified from the control unit 142, to a device other than the inspection support device 2 (for example, a server).

The various lamps 12 include, for example, a brake lamp, a backlight, and the like. The various sensors 13 include, for example, a sensor for detecting depression of a brake pedal, a sensor for detecting that a gear is put into reverse, and the like.

The ECU 14 is a control device for electronically controlling each part of the vehicle 1 by a computer. The storage unit 141 is configured by, for example, a read only memory (ROM), a random access memory (RAM), and the like. The storage unit 141 stores various programs and various types of data for causing the control unit 142 to function. The storage unit 141 may be a computer-readable storage medium.

The control unit 142 controls each part of the vehicle 1 by executing a program stored in the storage unit 141. For example, the control unit 142 turns on or turns off the various lamps 12 in accordance with information received from the inspection support device 2 via the in-vehicle wireless device 11. In addition, the control unit 142 transmits information, which is created based on detection results detected by the various sensors 13, to the inspection support device 2 via the in-vehicle wireless device 11.

### Configuration of Inspection Support Device 2

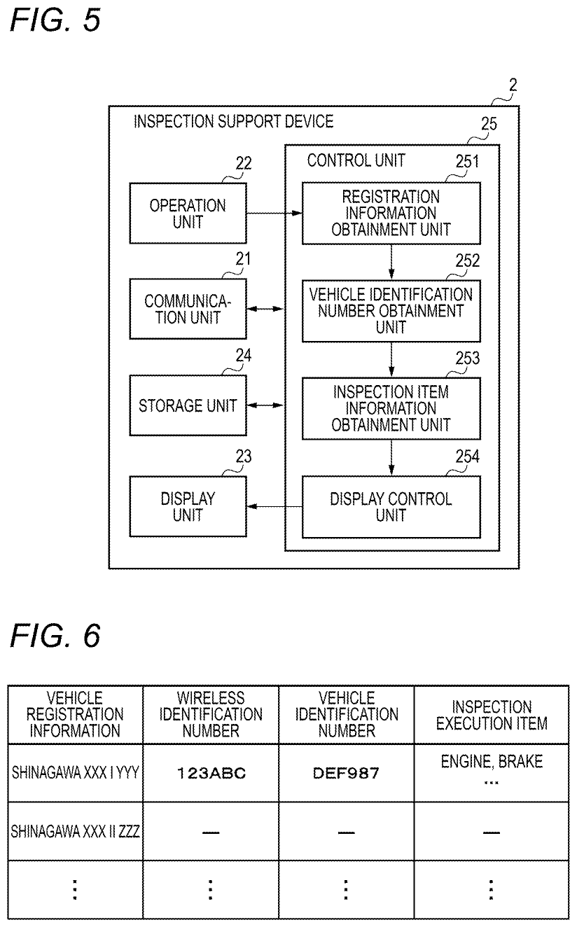

FIG. 5 is a diagram illustrating a configuration of the inspection support device 2. The inspection support device 2 includes a communication unit 21, an operation unit 22, a display unit 23, a storage unit 24, and a control unit 25. The communication unit 21 is a communication module for communicating with the vehicle 1 by wireless communication.

The operation unit 22 receives an operation performed by the user U. The operation unit 22 includes various buttons of the inspection support device 2 and a touch panel superimposed on the display unit 23. The operation unit 22 detects that the user U performs an operation, and notifies the control unit 25 of detected operation content. The display unit 23 is a display that displays various screens, and is, for example, a liquid crystal display.

The storage unit 24 is configured by, for example, a ROM, a RAM, and the like. The storage unit 24 stores various programs for causing the control unit 25 to function. The storage unit 24 stores the vehicle registration information, a wireless identification number, and a vehicle identification number in association with one another.

Wireless identification information is information for identifying the in-vehicle wireless device 11 of the vehicle 1. For example, the information for identifying the in-vehicle wireless device 11 is a service set identifier (SSID) of the in-vehicle wireless device 11. The wireless identification information may include an encryption key for connecting to the in-vehicle wireless device 11.

The vehicle identification number is a number unique to the vehicle 1 for identifying the vehicle 1, and is, for example, a vehicle identification number. The vehicle identification number includes information indicating a type of the vehicle. The vehicle identification number may include information of equipment mounted on the vehicle 1, such as an engine, a body, a chassis, and optional parts.

The storage unit 24 stores an inspection execution item of the vehicle 1 corresponding to vehicle registration information in association with the vehicle registration information. FIG. 6 is a schematic diagram of a data table in which vehicle registration information, a wireless identification number, a vehicle identification number, and an inspection execution item are associated. In the example of FIG. 6, vehicle registration information “Shinagawa XXX I YYY” is associated with wireless identification information “123ABC”, a vehicle identification number “DEF987”, and the inspection execution item.

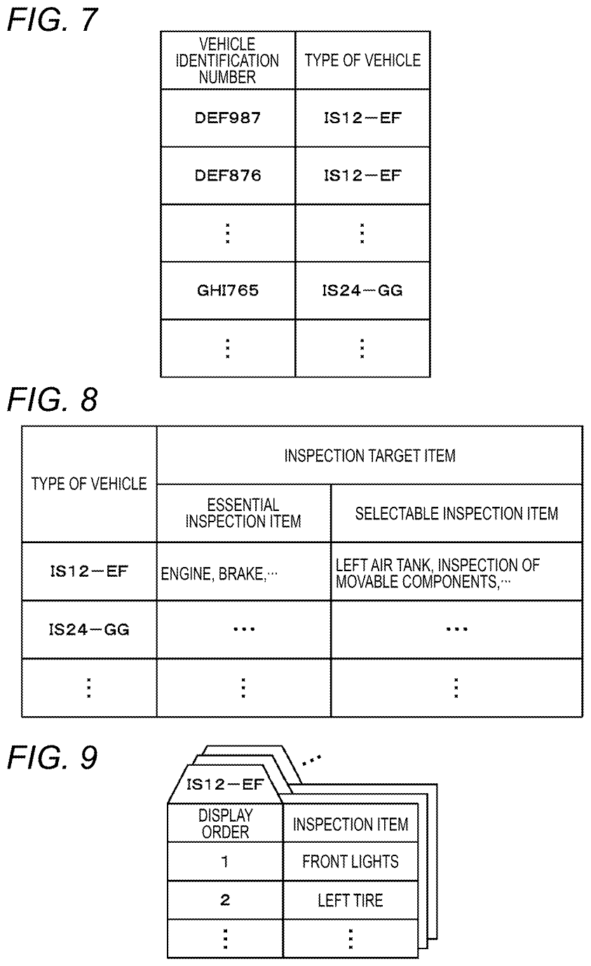

The storage unit 24 may store a vehicle identification number and a type of a vehicle indicated by the vehicle identification number in association with each other. The type of a vehicle is information for identifying a type or model of the vehicle. FIG. 7 is a schematic diagram of a data table in which a vehicle identification number and a type of a vehicle are associated with each other.

The storage unit 24 stores a type of a vehicle and a plurality of inspection items in association. FIG. 8 is a schematic diagram of a data table in which a type of a vehicle is associated with a plurality of inspection items. For example, the storage unit 24 stores, in association with a type of a vehicle, an essential inspection item whose inspection is essential for the vehicle of the type and a selectable inspection item whose inspection can be selectively performed. The selectable inspection item is directed to, for example, inspection of an optional part that is provided or not provided in the vehicle 1, or inspection recommended by a manufacturer of the vehicle 1.

The storage unit 24 stores a display order and an inspection item in association with each other for each type of vehicle. FIG. 9 is a schematic diagram of a data table in which a display order and an inspection item are associated for each type of vehicle.

The control unit 25 includes a processor such as a central processing unit (CPU). The control unit 25 functions as a registration information obtainment unit 251, a vehicle identification number obtainment unit 252, an inspection item information obtainment unit 253, and a display control unit 254 by executing a program stored in the storage unit 24.

The registration information obtainment unit 251 obtains vehicle registration information corresponding to the vehicle 1 to be inspected. For example, the registration information obtainment unit 251 obtains vehicle registration information selected by the user U from a plurality of pieces of vehicle registration information displayed on the display unit 23.

The vehicle identification number obtainment unit 252 obtains a vehicle identification number indicating a type of the vehicle 1. For example, the vehicle identification number obtainment unit 252 obtains the vehicle identification number from the in-vehicle wireless device 11 that has wireless identification information associated with the vehicle registration information obtained by the registration information obtainment unit 251. Specifically, the vehicle identification number obtainment unit 252 obtains the vehicle identification number from the in-vehicle wireless device 11 communicably connected to the inspection support device 2. In addition, the vehicle identification number obtainment unit 252 may refer to a data table stored in the storage unit 24 in which the vehicle registration information, the wireless identification number, the vehicle identification number, and the inspection execution item are associated with one another, and obtain the vehicle identification number associated with a vehicle registration number obtained by the registration information obtainment unit 251.

The inspection item information obtainment unit 253 refers to a data table stored in the storage unit 24 in which a type of a vehicle is associated with a plurality of inspection items, and obtains inspection item information indicating a plurality of inspection items associated with the type of the vehicle indicated by the vehicle identification number obtained by the vehicle identification number obtainment unit 252.

The display control unit 254 causes the display unit 23 to display, in an order associated with the type of the vehicle indicated by the vehicle identification number, a plurality of inspection screens corresponding to the plurality of inspection items indicated by the inspection item information obtained by the inspection item information obtainment unit 253. Specifically, according to the display order indicated by a data table stored in the storage unit 24 in which a display order and an inspection item are associated for each type of vehicle, the display control unit 254 causes the display unit 23 to display the inspection screens corresponding to the inspection items associated with the display order.

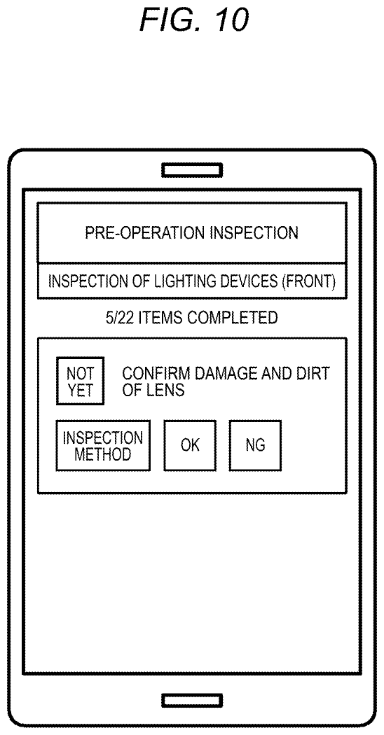

FIG. 10 is a schematic diagram illustrating an example of an inspection screen. The inspection screen illustrated in FIG. 10 is an example of an inspection screen corresponding to an inspection item to be performed by the user U at the front of the vehicle 1. For example, the display control unit 254 displays the inspection screen illustrated in FIG. 10 as a first inspection screen on the display unit 23. The user U can input an inspection result by operating an “OK” key or an “NG” key. The display control unit 254 displays a next inspection screen of the inspection screen being displayed on the display unit 23 on condition that an input of an inspection result corresponding to the displayed inspection screen is received. Specifically, when the “OK” key or the “NG” key is operated, the display control unit 254 causes the display unit 23 to display an inspection screen corresponding to an inspection item associated with a next display order of the display order of the inspection item corresponding to the inspection screen being displayed. In the case of the example of FIG. 3, after displaying the first inspection screen corresponding to the inspection item performed at the front, the display control unit 254 causes the display unit 23 to display the second inspection screen corresponding to an inspection item to be performed in the vicinity of a left tire of the vehicle 1.

The display control unit 254 may cause the inspection screen corresponding to the inspection item performed at the driver's seat of the vehicle 1 to be displayed lastly. For example, when inputs of inspection results for a plurality of inspection items excluding an inspection item to be performed at the driver's seat are received, the display control unit 254 causes the display unit 23 to display the inspection screen corresponding to the inspection item to be performed at the driver's seat. In this way, the inspection of the vehicle 1 can be completed while the user is in the vehicle 1, and thus the user U can quickly start the operation of the vehicle 1.

After a plurality of inspection results for a plurality of inspection execution items associated with selected vehicle registration information are input, the display control unit 254 displays an inspection result screen on the display unit 23. In addition, the display control unit 254 may transmit the input inspection results to an information terminal of an administrator. For example, the display control unit 254 causes the display unit 23 to display an inspection result screen including a transmission button for receiving an operation of transmitting the inspection results, and transmits the inspection results to the information terminal of the administrator when the transmission button is selected. In this way, the inspection support device 2 can reduce the time and effort for the user U to transmit the inspection results to the administrator.

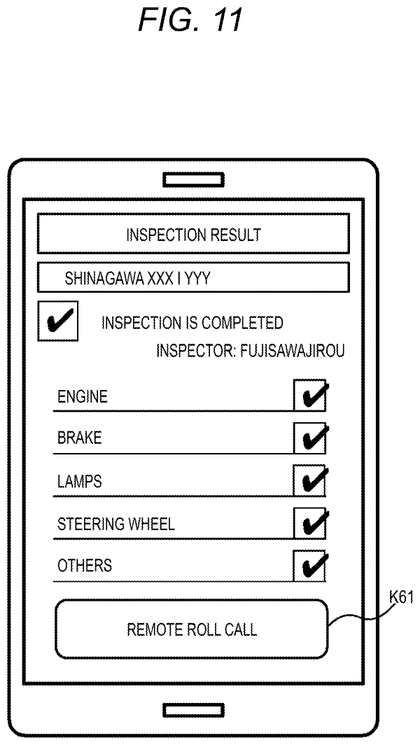

In addition, the display control unit 254 may cause the display unit 23 to display a remote roll call screen for performing a roll call to be performed by the administrator who manages the operation of the vehicle, on condition that an inspection result for each of a plurality of inspection items is input. Specifically, the display control unit 254 displays an inspection result screen including a remote roll call operation button for performing a remote roll call. FIG. 11 is a schematic diagram illustrating an example of an inspection result screen including a remote roll call operation button. A “remote roll call” key K61 in FIG. 11 is an example of a remote roll call operation button for receiving an operation of performing a remote roll call.

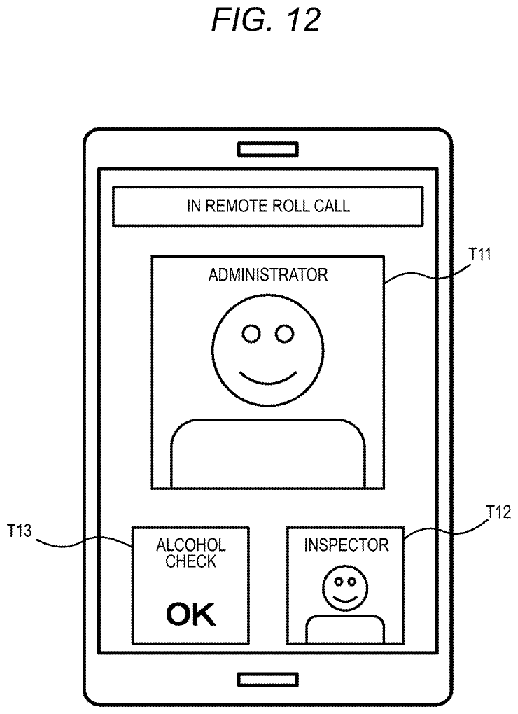

When the remote roll call operation button is selected, the display control unit 254 causes the display unit 23 to display the remote roll call screen. FIG. 12 is a schematic diagram illustrating an example of the remote roll call screen. For example, the display control unit 254 causes an administrator display portion T11 to display an image of an administrator who is to perform a roll call, and causes an inspector display portion T12 to display an image of the user U who operates the vehicle 1 after the inspection. In addition, the display control unit 254 may cause a roll call item display portion T13 to display items that need to be recorded in the roll call. For example, the display control unit 254 causes the roll call item display portion T13 to display a detection result of an alcohol detector interlocking with the inspection support device 2. In the example of FIG. 12, “OK” indicating that there is no problem in the operation of the vehicle is displayed as a result of alcohol detection. The display control unit 254 may transmit the detection result of the alcohol detector to the information terminal of the administrator. As described above, when the inspection support device 2 displays all inspection items of the vehicle 1 and then transmits the inspection results and displays the remote roll call screen, the user U can quickly receive a roll call of the administrator after the inspection of the vehicle 1 is completed.

### Modification 1

For some inspection item, inspection of the inspection item can be omitted until a predetermined period elapses after the inspection of the inspection item is performed. In this case, the work time of the inspection work can be shortened for the user U by omitting the inspection. However, when inspection of a displayed inspection item is omitted by the user U, an optimum inspection order may change.

Therefore, when it is input to the inspection support device 2 that inspection corresponding to an inspection screen displayed on the display unit 23 is not to be performed, the display control unit 254 changes an order of displaying inspection screens corresponding to inspection items on the display unit 23. In this case, the storage unit 24 stores a display order of a case where inspection of a selectable inspection item whose inspection can be selectively performed is to be performed, and a display order of a case where the inspection of the selectable inspection item is omitted. Specifically, the storage unit 24 stores a first data table in which a plurality of inspection items including a selectable inspection item to be performed are associated with a display order, and a second data table in which a plurality of inspection items not including a selectable inspection item to be omitted are associated with a display order.

When an operation for omitting an input of an inspection result of an inspection item displayed on the display unit 23 is input, the display control unit 254 causes the display unit 23 to display an inspection screen in accordance with the display order indicated by the second data table stored in the storage unit 24. In this way, even when the user U omits inspection, the inspection support device 2 can perform inspection in an order suitable for a type of a vehicle.

### Modification 2

Not limited to the above description, the inspection support system S may include an inspection management device capable of communicating with the inspection support device 2. The inspection management device has at least a part of functions of an inspection application. The inspection management device is, for example, a server managed by a business operator who inspects the vehicle 1. Further, the inspection management device may have all functions of the inspection application. In this case, a display control unit of the inspection management device causes the inspection support device 2 of the user U who inspects the vehicle 1 to display various types of information. Specifically, the display control unit of the inspection management device causes the inspection support device 2 to display, in an order associated with the type of the vehicle indicated by a vehicle identification number, a plurality of inspection screens corresponding to a plurality of inspection items.

### Effects of Inspection Support Device 2 According to Embodiment

As described above, the inspection support device 2 displays a plurality of inspection screens corresponding to a plurality of inspection items for inspection of the vehicle 1, in an order associated with the type of the vehicle 1 indicated by a vehicle identification number. In this way, the user U can perform inspection in an order suitable for the vehicle 1 to be inspected.

Although the present invention has been described above using the embodiment, the technical scope of the present invention is not limited to the scope described in the above embodiment, and various modifications and changes can be made within the scope of the gist of the present invention. For example, all or some of the devices may be functionally or physically distributed or integrated in any unit. Further, new embodiments generated by any combination of a plurality of embodiments are also contained in the embodiment of the present invention. Effects of the new embodiments generated by the combination include effects of the original embodiment.

The present application is based on Japanese Patent Application No. 2019-110530 filed on Jun. 13, 2019, contents of which are incorporated herein as reference.

### INDUSTRIAL APPLICABILITY

The present invention has an effect of performing inspection in an order suitable for a vehicle and is useful in, for example, an inspection support program, an inspection support system, and a control method for an inspection support device that support inspection of the vehicle.

### REFERENCE SIGNS LIST

S Inspection support system

1 Vehicle

11 In-vehicle wireless device

12 Various lamps

13 Various sensors

14 ECU

141 Storage unit

142 Control unit

2 Inspection support device

21 Communication unit

22 Operation unit

23 Display unit

24 Storage unit

25 Control unit

251 Registration information obtainment unit

252 Vehicle identification number obtainment unit

253 Inspection item information obtainment unit

254 Display control unit

U User

1. A non-transitory computer-readable medium storing
an inspection support program for supporting inspection of a vehicle readable by a computer, the inspection support program, when executed by the computer, causing the computer to perform:
obtaining a vehicle identification number indicating a type of the vehicle; and
controlling a display to display a plurality of inspection screens corresponding to a plurality of inspection items in an order associated with the type of the vehicle indicated by the vehicle identification number.

2. The non-transitory computer-readable medium according to claim 1, wherein in the controlling of the display, the inspection support program, when executed by the computer, further causes the computer to perform:
controlling the display to display the inspection screen corresponding to an inspection item to be performed at a driver's seat of the vehicle lastly.

3. The non-transitory computer-readable medium according to claim 1, wherein in the controlling of the display, the inspection support program, when executed by the computer, further causes the computer to perform:
after all of the plurality of inspection screens are displayed, controlling the display to display a remote roll call screen for performing a roll call to be performed by an administrator who manages operation of the vehicle.

4. The non-transitory computer-readable medium according to claim 1, wherein in the controlling of the display, the inspection support program, when executed by the computer, further causes the computer to perform:
changing the order in a case the computer receives an instruction of not to perform inspection corresponding to the inspection screen displayed on the display.

5. The non-transitory computer-readable medium according to claim 1, wherein in the controlling of the display, the inspection support program, when executed by the computer, further causes the computer to perform:
controlling the display to display the plurality of inspection screens corresponding to the plurality of inspection items in an order of going around the vehicle from front of the vehicle to a driver's seat of the vehicle.

6. The non-transitory computer-readable medium according to claim 5,
wherein the plurality of inspection items include:
a first inspection item corresponding to an inspection item to be performed at the front;
a second inspection item corresponding to an inspection item to be performed at a periphery of the vehicle; and
a third inspection item corresponding to an inspection item to be performed at the driver's seat, and
wherein in the controlling of the display, the inspection support program, when executed by the computer, further causes the computer to perform:
displaying firstly a first inspection screen corresponding to the first inspection item; and
displaying lastly a third inspection screen corresponding to the third inspection item.

7. An inspection support system for supporting inspection of a vehicle, the inspection support system comprising:
an information terminal comprising:
a display; and
a controller configured to:
obtain a vehicle identification number indicating a type of the vehicle; and
control the information terminal of a user, who performs inspection of the vehicle, to display a plurality of inspection screens corresponding to a plurality of inspection items in an order associated with the type of the vehicle indicated by the vehicle identification number on the display.

8. A control method for an inspection support device for supporting inspection of a vehicle, the control method comprising causing the inspection support device to perform:
obtaining a vehicle identification number indicating a type of the vehicle; and
controlling a display to display a plurality of inspection screens corresponding to a plurality of inspection items in an order associated with the type of the vehicle indicated by the vehicle identification number.
